(19) United States
(12) Patent Application Publication
(10) Pub. No.: US 2020/0056483 A1
(43) Pub. Date: Feb. 20, 2020

(54) TURBINE BLADES AND VANES FOR GAS TURBINE ENGINE

(71) Applicant: United Technologies Corporation, Farmington, CT (US)

(72) Inventors: William J. Joost, Hartford, CT (US); Pantcho P. Stoyanov, West Hartford, CT (US)

(21) Appl. No.: 16/104,584

(22) Filed: Aug. 17, 2018

(51) Int. Cl. F01D 5/06; F04D 19/02; F04D 29/32; F04D 29/60

(52) U.S. Cl. CPC F01D 5/066; F04D 19/02; F04D 29/321; F04D 29/601; F05D 2220/323; F05D 2230/311; F05D 2300/13; F05D 2230/314; F05D 2230/40; F05D 2230/60; F05D 2240/24; F05D 2300/701; F05D 2300/611; F05D 2230/312

(57) ABSTRACT

A gas turbine engine is provided and includes a first rotating component having a first snap surface and a second rotating component having a second snap surface. The first and second snap surfaces are configured to interlock along an interface and at least one of the first and second snap surfaces comprising a tailored-friction material at the interface.

### BACKGROUND

Exemplary embodiments of the present disclosure relate generally to rotor stacks and, in one embodiment, to a reduced static friction coating for a snap location of a rotor stack.

A gas turbine engine typically includes a fan section, a compressor section, a combustor section and a turbine section. Air entering the compressor section is compressed and delivered into the combustion section where it is mixed with fuel and ignited to generate a high-energy exhaust gas flow. The high-energy exhaust gas flow expands through the turbine section to drive the compressor and the fan section. The compressor section typically includes low and high pressure compressors, and the turbine section includes low and high pressure turbines.

The gas turbine engine includes a plurality of rotors arranged along an axis of rotation of the gas turbine engine, in both the compressor section and the turbine section. At least some of these rotors are connected to axially adjacent rotors, spacers or other rotating components via an interference fit, also known in the art as a “snap fit.”

The areas surrounding the interference fit and the surfaces forming the interference fit can experience a significant amount of wear and stress. Accordingly, improved materials are desired for a more effective and efficient interference fit.

### BRIEF DESCRIPTION

According to an aspect of the disclosure, a gas turbine engine is provided and includes a first rotating component having a first snap surface and a second rotating component having a second snap surface. The first and second snap surfaces are configured to interlock along an interface and at least one of the first and second snap surfaces comprising a tailored-friction material at the interface.

In accordance with additional or alternative embodiments, the first and second rotating components are adjacent to one another.

In accordance with additional or alternative embodiments, at least one of the first and second rotating components includes a platform or a spacer.

In accordance with additional or alternative embodiments, the tailored-friction material includes a lubricious oxide.

In accordance with additional or alternative embodiments, the lubricious oxide includes at least one of ruthenium (Ru), molybdenum (Mo), tungsten (W) and niobium (Nb).

In accordance with additional or alternative embodiments, a thickness of the tailored-friction material at the interface is less than or equal to 1 micrometer.

In accordance with additional or alternative embodiments, one of the first and second snap surfaces faces radially inwardly at the interface and the other of the first and second snap surfaces faces radially outwardly at the interface.

In accordance with additional or alternative embodiments, one of the first and second snap surfaces includes a radially inwardly facing surface and an axial surface facing in a first axial direction and the other of the first and second snap surfaces comprises a radially outwardly facing surface and an axial surface facing in a second axial direction opposite the first axial direction.

According to another aspect of the disclosure, a gas turbine engine is provided and includes a first rotating component having an aft snap surface at an aft edge thereof, a second rotating component having a forward snap surface at a forward edge thereof and third, fourth, fifth and sixth rotating components respectively having aft and forward snap surfaces at respective aft and respective forward edges thereof. Each aft snap surface of the first, third, fourth, fifth and sixth rotating components are configured to interlock with a corresponding forward snap surface of the third, fourth, fifth, sixth and second rotating components along first, second, third, fourth and fifth interfaces, respectively. At least one of the aft and forward snap surfaces includes a tailored-friction material at at least one of the first, second, third, fourth and fifth interfaces.

In accordance with additional or alternative embodiments, the first and third rotating components are adjacent to one another, the third and fourth rotating components are adjacent to one another, the fourth and fifth rotating components are adjacent to one another, the fifth and sixth rotating components are adjacent to one another and the sixth and second rotating components are adjacent to one another.

In accordance with additional or alternative embodiments, at least one of the first, third, fourth, fifth, sixth and second rotating components includes a platform or a spacer.

In accordance with additional or alternative embodiments, the tailored-friction material includes a lubricious oxide.

In accordance with additional or alternative embodiments, the lubricious oxide includes at least one of ruthenium (Ru), molybdenum (Mo), tungsten (W) and niobium (Nb).

In accordance with additional or alternative embodiments, a thickness of the tailored-friction material at the at least one of the first, second, third, fourth and fifth interfaces is less than or equal to 1 micrometer.

In accordance with additional or alternative embodiments, at one or more of the first, second, third, fourth and fifth interfaces one of the aft and forward snap surfaces faces radially inwardly and the other of the aft and forward snap surfaces faces radially outwardly.

In accordance with additional or alternative embodiments, at one or more of the first, second, third, fourth and fifth interfaces one of the aft and forward snap surfaces comprises a radially inwardly facing surface and an axial surface facing in a first axial direction and the other of the aft and forward snap surfaces comprises a radially outwardly facing surface and an axial surface facing in a second axial direction opposite the first axial direction.

According to another aspect of the disclosure, a method of interlocking aft and forward snap surfaces of first and second rotating components of a gas turbine engine is provided. The method includes energetically applying a precursor material of a lubricious oxide to at least one of the aft and forward snap surfaces and executing a heat treatment of the precursor material to generate the lubricious oxide as a film on the at least one of the aft and forward snap surfaces.

In accordance with additional or alternative embodiments, the energetically applying includes at least one of thermal spraying, atomic layer deposition, chemical deposition and plasma deposition.

In accordance with additional or alternative embodiments, the executing of the heat treatment includes heating the precursor material to encourage oxidization thereof.

In accordance with additional or alternative embodiments, the method further includes thermally adjusting relative sizes of the first and second rotating components until the first and second rotating components are fittable together and thermally releasing at least one of the first and second rotating components to assume an original size thereof.

These and other advantages and features will become more apparent from the following description taken in conjunction with the drawings.

### BRIEF DESCRIPTION OF THE DRAWINGS

The following descriptions should not be considered limiting in any way. With reference to the accompanying drawings, like elements are numbered alike:

FIG. 1 is a partial cross-sectional view of a gas turbine engine;

FIG. 2 is a partial cross-sectional view of an embodiment of a portion of a compressor section of the gas turbine engine of FIG. 1;

FIG. 3 is a partial cross-sectional view of another embodiment of a portion of a compressor section of the gas turbine engine of FIG. 1;

FIG. 4 is a partial cross-sectional view of an embodiment of a compressor rotor of the gas turbine engine of FIG. 1;

FIG. 5A is a side view of a portion of a gas turbine engine with snap locations in accordance with embodiments;

FIG. 5B is a schematic illustration of a tailored-friction film formed at the snap locations of FIG. 5A;

FIG. 6 is a flow diagram illustrating a method of interlocking aft and forward snap surfaces of first and second rotating components of a gas turbine engine in accordance with embodiments;

FIG. 7 is a schematic diagram illustrating a method of energetically applying a precursor material in accordance with embodiments;

FIG. 8 is a schematic diagram illustrating a method of energetically applying a precursor material in accordance with further embodiments; and

FIG. 9 is a graphical illustration of a comparison between static friction coefficients.

These and other advantages and features will become more apparent from the following description taken in conjunction with the drawings.

### DETAILED DESCRIPTION

A detailed description of one or more embodiments of the disclosed apparatus and method are presented herein by way of exemplification and not limitation with reference to the Figures.

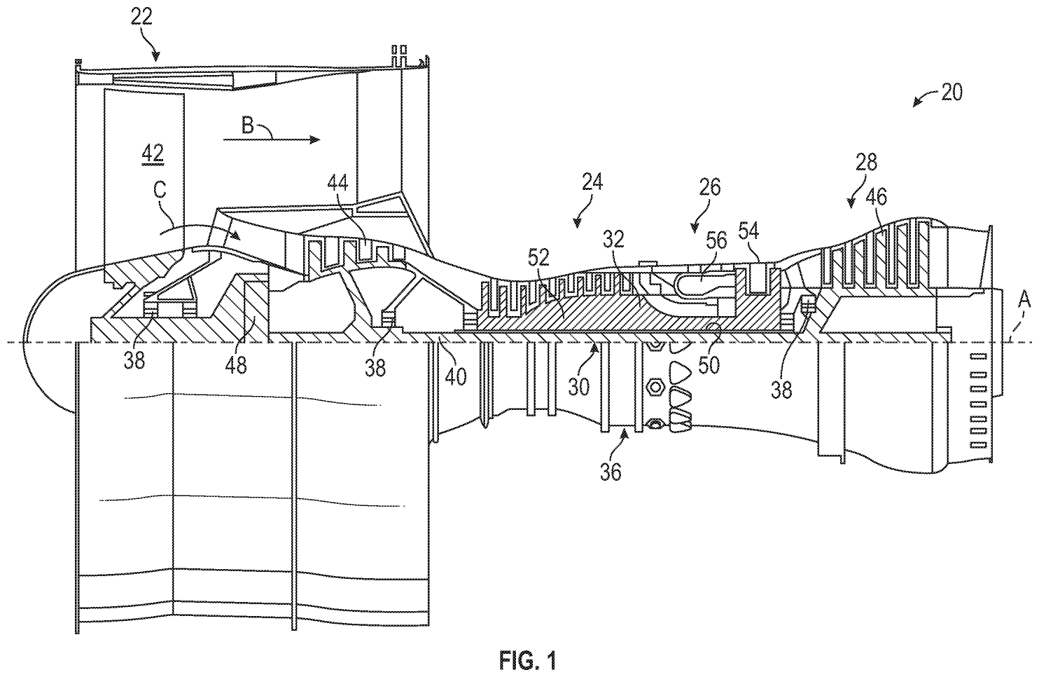

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include other systems or features. The fan section 22 drives air along a bypass flow path B in a bypass duct, while the compressor section 24 drives air along a core flow path C for compression and communication into the combustor section 26 and then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary gas turbine engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in the gas turbine engine 20 between the high pressure compressor 52 and the high pressure turbine 54. The engine static structure 36 is arranged generally between the high pressure turbine 54 and the low pressure turbine 46. The engine static structure 36 further supports the bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 and then the high pressure compressor 52, is mixed and burned with fuel in the combustor 56 and is then expanded over the high pressure turbine 54 and the low pressure turbine 46. The high and low pressure turbines 54 and 46 rotationally drive the low speed spool 30 and the high speed spool 32, respectively, in response to the expansion. It will be appreciated that each of the positions of the fan section 22, compressor section 24, combustor section 26, turbine section 28, and fan drive gear system 48 may be varied. For example, geared architecture 48 may be located aft of the combustor section 26 or even aft of the turbine section 28, and the fan section 22 may be positioned forward or aft of the location of geared architecture 48.

The gas turbine engine 20 in one example is a high-bypass geared aircraft engine. In a further example, the gas turbine engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the gas turbine engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the gas turbine engine 20 is designed for a particular flight condition—typically cruise at about 0.8 Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram °R)/(518.7°R)]0.5. The “Low corrected fan tip speed” as disclosed herein according to one non-limiting embodiment is less than about 1150 ft/second (350.5 m/sec).

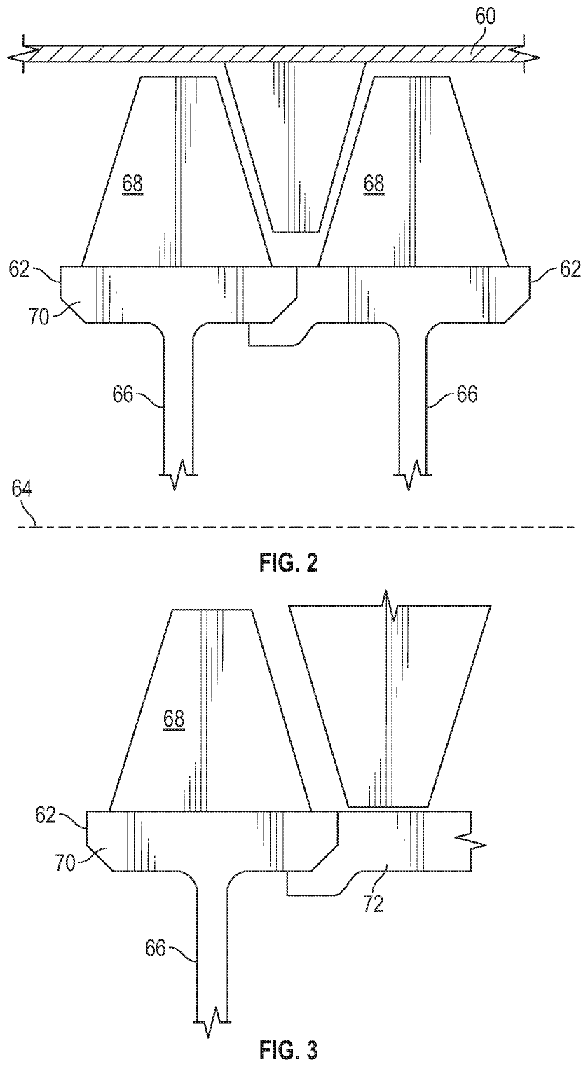

Referring now to FIG. 2, either or both of the low pressure compressor 44 or the high pressure compressor 52 includes a compressor case 60, in which compressor rotors 62 are arranged along an engine axis 64 about which the compressor rotors 62 rotate. Each compressor rotor 62 includes a rotor disc 66 with a platform 70 and a plurality of rotor blades 68 extending radially outwardly from the platform 70 (i.e., a rotor stack). In some embodiments, the rotor disc 66 and the plurality of rotor blades 68 are a single, unitary structure, an integrally bladed compressor rotor 62. In other embodiments, the rotor blades 68 are each installed to the rotor disc 66 via, for example, a dovetail joint where a tab or protrusion at the rotor blade 68 is inserted into a corresponding slot in the platform 70.

As shown in FIG. 2, axially adjacent compressor rotors 62 may be joined to each other, while in other embodiments, as shown in FIG. 3, the compressor rotor 62 may be joined to another rotating component, such as a spacer 72. The compressor rotor 62 is secured to the adjacent rotating component by an interference fit or a “snap fit,” which in some embodiments is combined with another mechanical fastening, such as a plurality of bolts (not shown) to secure the components and to form or define a snap location.

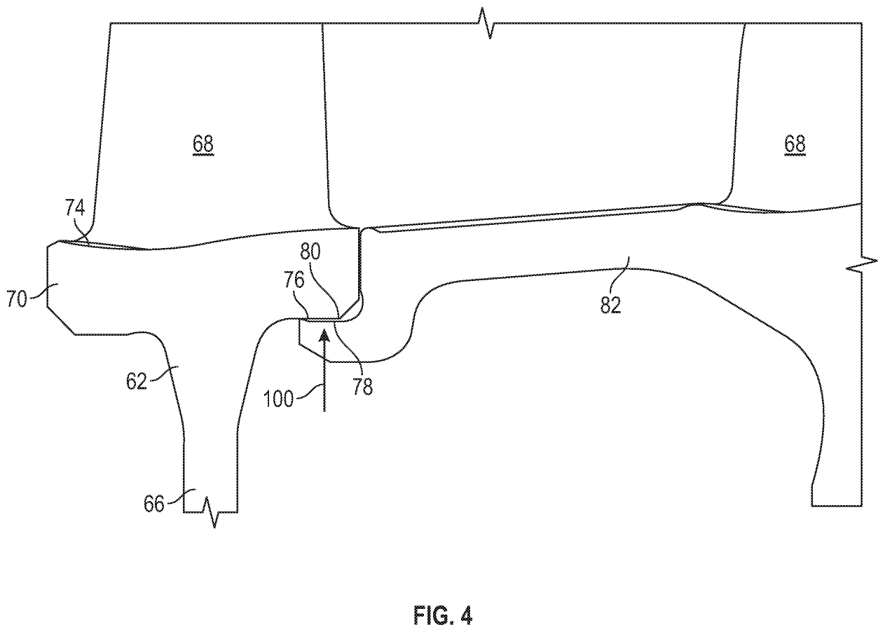

Referring now to FIG. 4, a more detailed view of the interference fit between the compressor rotor 62 and the adjacent rotating component is shown. The compressor rotor 62, as stated above, includes a plurality of rotor blades 68 secured to, and radially extending from a platform 70 of a rotor disc 66. The platform 70 extends in a substantially axial direction, and includes a flowpath surface 74 that defines an inner boundary of a flowpath of the gas turbine engine 20. A radially inboard platform surface 76, which is opposite the flowpath surface 74 and radially inboard therefrom, defines a rotor snap surface 78. The rotor snap surface 78 interfaces with an adjacent component snap surface 80 to join the compressor rotor 62 and the adjacent component 82 at the snap location R5-R6 (an additional snap location R4-R5 is provided forward of the compressor rotor 62 of FIG. 4 and additional snap locations R6-R7 and R7-R8 are provided aft of the compressor rotor 62 of FIG. 4 but need not be described further).

In their respective free, unrestrained states and when they are unjoined, the adjacent component snap surface 80 is larger than the rotor snap surface 78. Thus, in order to accomplish the joining at the snap location R5-R6, the compressor rotor 62 may be heated and/or the adjacent component 82 may be cooled to temporarily enlarge the rotor snap surface 78 relative to the adjacent component snap surface 80. Once the rotor snap surface 78 and the adjacent component snap surface 80 are subsequently joined and returned to ambient temperature, the desired interference fit is achieved between the rotor snap surface 78 and the adjacent component snap surface 80.

Materials currently used at the snap locations R4-R5, R5-R6, R6-R7 and R7-R8 typically include PWA1115, PWA1193, PWA1227 and PWA36280 and the design of the rotor stack interface (i.e., the interference fit between the rotor snap surface 78 and the adjacent component snap surface 80 of FIG. 4) is highly dependent on static friction behaviors of the rotor snap surface 78 and the adjacent component snap surface 80 at the rotor stack interface and it is understood that a decrease in a static friction coefficient of one or both of the rotor snap surface 78 and the adjacent component snap surface 80 at elevated temperatures would allow for slight movement at the rotor stack interface due to thermal expansion. Such movement would be expected to reduce wear at the rotor stack interface and can potentially decrease overall stresses within the rotor snap surface 78 and the adjacent component snap surface 80. Therefore, a rotor stack interface with a tailored static friction coefficient at elevated temperatures (as compared to conventional interfaces with the Ni-based and Ti-based alloys) is provided.

In accordance with embodiments, the rotor stack interface includes surfaces, such as the rotor snap surface 78 and the adjacent component snap surface 80 of FIG. 4, which are coated or modified (the coating or modification will hereinafter be referred to as a “modification 100” as shown in FIG. 4) and formed such that static and possibly dynamic friction at the rotor stack interface is reduced as compared to what is otherwise possible with conventional materials. In particular, the modification 100 includes the disposition of lubricous or tailored-friction oxides at one or more of the snap locations R4-R5, R5-R6, R6-R7 and R7-R8 where PWA1115, PWA1193, PWA1227 and PWA36280 materials are used. In an exemplary case, a molybdenum (Mo)-based coating is applied on at least one of the rotor snap surface 78 and the adjacent component snap surface 80 by means of thermal spraying. The Mo-based coating is then exposed to elevated temperatures to convert the MO-based coating into Mo-oxide.

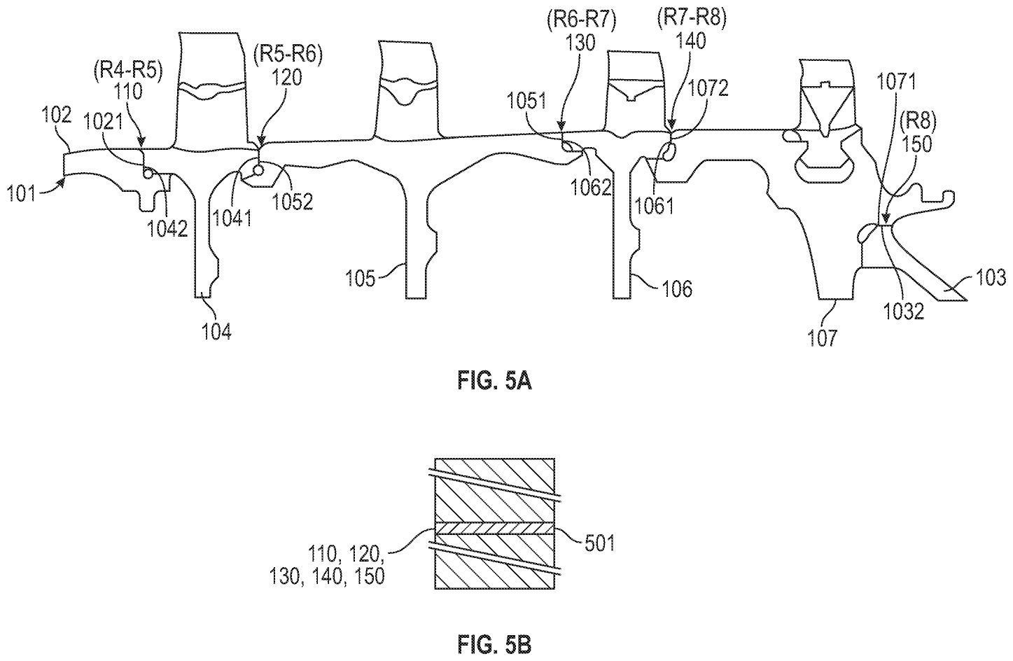

With reference to FIGS. 5A and 5B, a portion 101 of a gas turbine engine is provided and includes a first rotating component 102, a second rotating component 103, a third rotating component 104, a fourth rotating component 105, a fifth rotating component 106 and a sixth rotating component 107. The first and third rotating components 102 and 104 may be adjacent to one another. The third and fourth rotating components 104 and 105 may be adjacent to one another. The fourth and fifth rotating components 105 and 106 may be adjacent to one another. The fifth and sixth rotating components 106 and 107 may be adjacent to one another. The sixth and second rotating components 107 and 103 may be adjacent to one another. At least one of the first, third, fourth, fifth, sixth and second rotating components 102, 104, 105, 106, 107 and 103 includes a platform or a spacer (see platform 70 and spacer 72 of FIG. 3).

The first rotating component 102 may be provided as a rotor stack and has an aft snap surface 1021 at an aft edge thereof. The second rotating component 103 may be provided as a rotor stack and has a forward snap surface 1032 at a forward edge thereof. The third rotating component 104 may be provided as a rotor stack and has aft and forward snap surfaces 1041 and 1042 at aft and forward edges thereof. The fourth rotating component 105 may be provided as a rotor stack and has aft and forward snap surfaces 1051 and 1052 at aft and forward edges thereof. The fifth rotating component 106 may be provided as a rotor stack and has aft and forward snap surfaces 1061 and 1062 at aft and forward edges thereof. The sixth rotating component 107 may be provided as a rotor stack and has aft and forward snap surfaces 1071 and 1072 at aft and forward edges thereof.

The aft snap surface 1021 is configured to interlock with the forward snap surface 1042 along a first interface 110 (i.e., the R4-R5 snap location). The aft snap surface 1041 is configured to interlock with the forward snap surface 1052 along a second interface 120 (i.e., the R5-R6 snap location). The aft snap surface 1051 is configured to interlock with the forward snap surface 1062 along a third interface 130 (i.e., the R6-R7 snap location). The aft snap surface 1061 is configured to interlock with the forward snap surface 1072 along a fourth interface 140 (i.e., the R7-R8 snap location). The aft snap surface 1071 is configured to interlock with the forward snap surface 1032 along a fifth interface 150 (i.e., the R8 snap location).

At least one of the aft snap surfaces 1021, 1041, 1051, 1061 and 1071 or at least one of the forward snap surfaces 1032, 1042, 1052, 1062 and 1072 includes a tailored-friction material film 501 (see FIG. 5B). The tailored-friction material film 501 may include a lubricious oxide, such as at least one or more of ruthenium (Ru) oxide, molybdenum (Mo) oxide, tungsten (W) oxide and niobium (Nb) oxide. A thickness of the tailored-friction material film 501 at the at least one of the first, second, third, fourth and fifth interfaces 110, 120, 130, 140 and 150 may be less than or equal to 1 micrometer.

In accordance with embodiments, at one or more of the first, second, third, fourth and fifth interfaces 110, 120, 130, 140 and 150, one of the aft and forward snap surfaces faces radially inwardly (see, e.g., the adjacent component snap surface 80 of FIG. 4) and the other of the aft and forward snap surfaces faces radially outwardly (see, e.g., the rotor snap surface 78 of FIG. 4). Here, either of the aft and forward snap surfaces can include the tailored-friction material film 501. In accordance with further embodiments, one of the aft and forward snap surfaces includes a radially inwardly facing surface (see, e.g., the adjacent component snap surface 80 of FIG. 4) and an axial surface facing in a first axial direction (see, e.g., the adjacent component axial surface 801 of FIG. 4) and the other of the aft and forward snap surfaces includes a radially outwardly facing surface (see, e.g., the rotor snap surface 78 of FIG. 4) and an axial surface facing in a second axial direction opposite the first axial direction (see, e.g., the axial rotor snap surface 781 of FIG. 4). Here, again, either of the aft and forward snap surfaces can include the tailored-friction material film 501 at only the inward or outward radial surfaces or at both the inward or outward radial surfaces and the axial surfaces.

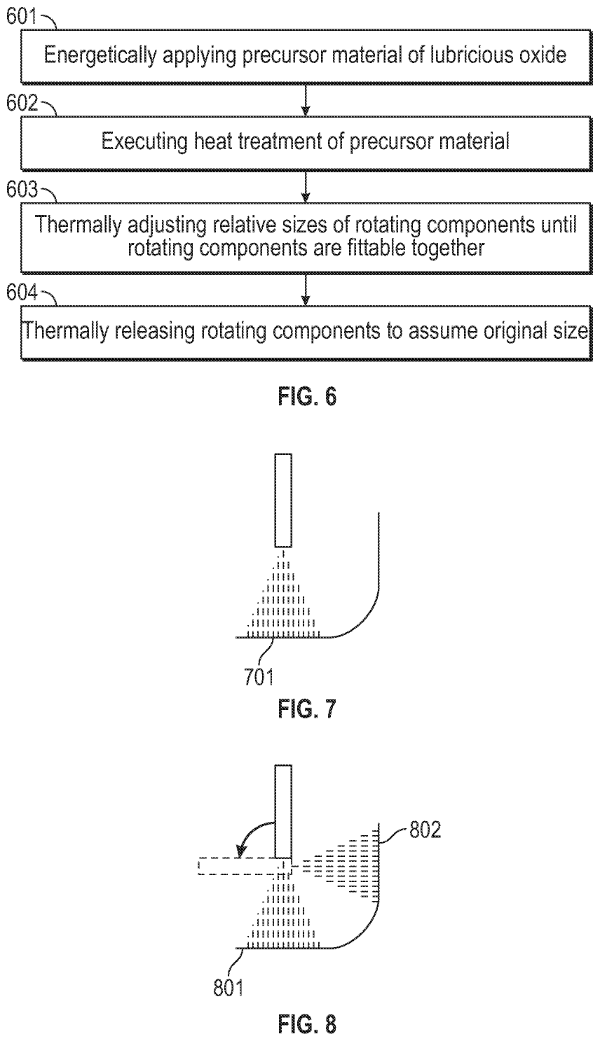

With reference to FIGS. 6, 7 and 8, a method of interlocking aft and forward snap surfaces of first and second rotating components of a gas turbine engine is provided.

As shown in FIG. 6, the method includes energetically applying a precursor material of a lubricious oxide to at least one of the aft and forward snap surfaces (601) and executing a heat treatment of the precursor material to encourage oxidization thereof and to thus generate the lubricious oxide as a film on the at least one of the aft and forward snap surfaces (602). The method may further include thermally adjusting relative sizes of the first and second rotating components until the first and second rotating components are fittable together (603) and thermally releasing at least one of the first and second rotating components to assume an original size thereof (604).

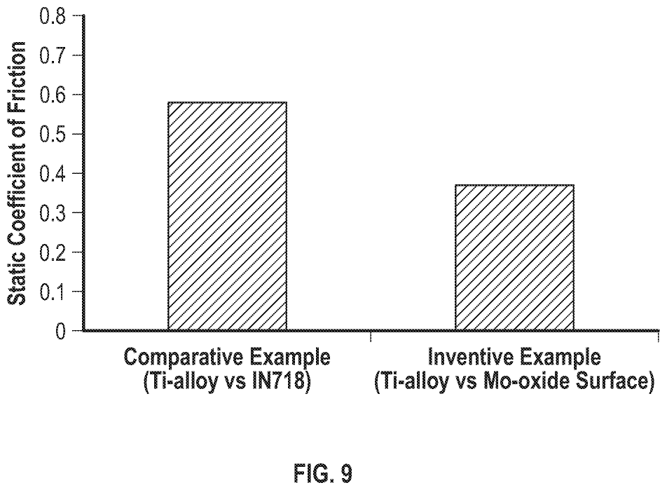

With reference to FIG. 7, the energetic application of the precursor material may include at least one of thermal spraying, atomic layer deposition, chemical deposition and plasma deposition of the precursor material locally onto a surface 701 that can face radially outwardly for example. Alternatively, with reference to FIG. 8, the energetic application of the precursor material may include at least one of non-localized thermal spraying, atomic layer deposition, chemical deposition and plasma deposition of the precursor material onto surfaces 801 and 802 that can face radially outwardly and axially for example.

With reference to FIG. 9, a graphical comparison of static friction coefficients at elevated temperatures (i.e., ˜800° F.) with conventional materials compared to the tailored-friction materials discussed herein is provided. As shown in FIG. 9, the static friction coefficients are evidently lower for the tailored-friction materials, and is behavior that can be attributed to the provision of the tailored-friction materials at the first, second, third, fourth and fifth interfaces 110, 120, 130, 140 and 150 of FIG. 5A.

Benefits of the features described herein are the provision of a tailored-friction film that offers reduced or tailored high temperature static friction capabilities at snap locations of rotor stack regions. This will significantly reduce stresses by allowing for easier movement between interfacing components due to thermal expansion. In addition, this technology may be applied to other engine interfaces where low static friction is desired.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A gas turbine engine, comprising:
a first rotating component having a first snap surface; and
a second rotating component having a second snap surface,
the first and second snap surfaces being configured to interlock along an interface, and
at least one of the first and second snap surfaces comprising a tailored-friction material at the interface.

2. The gas turbine engine according to claim 1, wherein the first and second rotating components are adjacent to one another.

3. The gas turbine engine according to claim 1, wherein at least one of the first and second rotating components comprises a platform or a spacer.

4. The gas turbine engine according to claim 1, wherein the tailored-friction material comprises a lubricious oxide.

5. The gas turbine engine according to claim 4, wherein the lubricious oxide comprises at least one of ruthenium (Ru), molybdenum (Mo), tungsten (W) and niobium (Nb).

6. The gas turbine engine according to claim 1, wherein a thickness of the tailored-friction material at the interface is less than or equal to 1 micrometer.

7. The gas turbine engine according to claim 1, wherein:
one of the first and second snap surfaces faces radially inwardly at the interface, and
the other of the first and second snap surfaces faces radially outwardly at the interface.

8. The gas turbine engine according to claim 1, wherein:
one of the first and second snap surfaces comprises a radially inwardly facing surface and an axial surface facing in a first axial direction, and
the other of the first and second snap surfaces comprises a radially outwardly facing surface and an axial surface facing in a second axial direction opposite the first axial direction.

9. A gas turbine engine, comprising:
a first rotating component having an aft snap surface at an aft edge thereof;
a second rotating component having a forward snap surface at a forward edge thereof,
third, fourth, fifth and sixth rotating components respectively having aft and forward snap surfaces at respective aft and respective forward edges thereof,
each aft snap surface of the first, third, fourth, fifth and sixth rotating components being configured to interlock with a corresponding forward snap surface of the third, fourth, fifth, sixth and second rotating components along first, second, third, fourth and fifth interfaces, respectively, and
at least one of the aft and forward snap surfaces comprising a tailored-friction material at at least one of the first, second, third, fourth and fifth interfaces.

10. The gas turbine engine according to claim 9, wherein:
the first and third rotating components are adjacent to one another,
the third and fourth rotating components are adjacent to one another,
the fourth and fifth rotating components are adjacent to one another,
the fifth and sixth rotating components are adjacent to one another, and
the sixth and second rotating components are adjacent to one another.

11. The gas turbine engine according to claim 9, wherein at least one of the first, third, fourth, fifth, sixth and second rotating components comprises a platform or a spacer.

12. The gas turbine engine according to claim 9, wherein the tailored-friction material comprises a lubricious oxide.

13. The gas turbine engine according to claim 12, wherein the lubricious oxide comprises at least one of ruthenium (Ru), molybdenum (Mo), tungsten (W) and niobium (Nb).

14. The gas turbine engine according to claim 9, wherein a thickness of the tailored-friction material at the at least one of the first, second, third, fourth and fifth interfaces is less than or equal to 1 micrometer.

15. The rotating component according to claim 9, wherein at one or more of the first, second, third, fourth and fifth interfaces:
one of the aft and forward snap surfaces faces radially inwardly, and
the other of the aft and forward snap surfaces faces radially outwardly.

16. The rotating component according to claim 1, wherein at one or more of the first, second, third, fourth and fifth interfaces:
one of the aft and forward snap surfaces comprises a radially inwardly facing surface and an axial surface facing in a first axial direction, and
the other of the aft and forward snap surfaces comprises a radially outwardly facing surface and an axial surface facing in a second axial direction opposite the first axial direction.

17. A method of interlocking aft and forward snap surfaces of first and second rotating components of a gas turbine engine, the method comprising:
energetically applying a precursor material of a lubricious oxide to at least one of the aft and forward snap surfaces; and
executing a heat treatment of the precursor material to generate the lubricious oxide as a film on the at least one of the aft and forward snap surfaces.

18. The method according to claim 17, wherein the energetically applying comprises at least one of thermal spraying, atomic layer deposition, chemical deposition and plasma deposition.

19. The method according to claim 17, wherein the executing of the heat treatment comprises heating the precursor material to encourage oxidization thereof.

20. The method according to claim 17, further comprising:
thermally adjusting relative sizes of the first and second rotating components until the first and second rotating components are finable together; and
thermally releasing at least one of the first and second rotating components to assume an original size thereof.
